(19) United States
(12) Patent Application Publication
(10) Pub. No.: US 2008/0070619 A1
(43) Pub. Date: Mar. 20, 2008

(54) Communication Network System Converging Wireless Mobile Network and Wired Discontinuous Mobile Network and Method Thereof

(76) Inventor: Jun Yu, Shenzhen (CN)

Correspondence Address: MATTHIAS SCHOLL, 14781 MEMORIAL DRIVE, SUITE 1319, HOUSTON, TX, 77079, US

(21) Appl. No.: 11/572,924

(22) PCT Filed: Jul. 28, 2005
(86) PCT No.: PCT/CN05/01146

§ 371 Date: Jan. 30, 2007

(30) Foreign Application Priority Data
Jul. 30, 2004 (CN) 200410050887.1

(51) Int. Cl. H04B 7/00

(52) U.S. Cl. 455/552.1

(57) ABSTRACT

A communication network system that converges a wireless mobile network and a wired discontinuous mobile network and the method thereof is provided herein, with the communication network system and method applicable to the wireless and wired communication technology fields. The convergent communication network includes a user equipment, an access network and a wireless/wired convergent mobile core network. The invention provides a convergence of a wireless mobile communication technology and a wired discontinuous mobile communication technology, and the convergence of wireless mobile communication and wired discontinuous mobile communication in terms of the system functions and structure of a core network, an access network, a user equipment, and a full network. The invention combines the respective advantages of wireless mobile communication and wired communication, overcomes the deficiencies thereof, and solves various problems with conventional wireless mobile communication and wired communication, such as separated networks, complex interconnection and interoperability, the waste and non-sharing of communication resources, and high cost.

### FIELD OF THE INVENTION

The invention relates to the communication technology field, and specifically to the technologies and network structures of wireless communication and wired communication, and particularly relates to a communication network system that converges a wireless mobile network with a wired discontinuous mobile network, and the method thereof.

### DESCRIPTION OF THE RELATED ART

Although conventional communication networks are capable of interconnecting and interoperating, these different communication networks are independent of each other due to the fact that the various independent communication core networks use different communication access network technologies, for example, the different wireless mobile access technologies, such as DAMPS, cdma IS-95A/B, GSM/GPRS, PDC/PHS, 3G WCDMA, CDMA2000, and so on are respectively connected to different wireless mobile core communication networks that are independent of each other. A traditional wired fixed access communication POTS corresponds to a wired fixed PSTN/ISDN core communication network; and IP packet access such as Ethernet, xDSL, a cable modem, and so on corresponds to a PDN packet network, the Internet, an IP communication network, and so on.

The wireless and mobile feature of conventional wireless mobile communication network technologies brings great flexibility and convenience to a user's communication, but the problems therewith, such as the insufficiency and costliness of wireless frequency resources, low security and privacy, bad communication environment, comparatively poor communication quality, requirements for high power radio frequency technologies, along with the increasing complexity of wireless mobile communication and control technologies, are inevitable and unsolvable. The wired communication network technologies, such as PSTN, have various advantages, such as friendly communication environments, abundant wired bandwidth resources, comparatively high communication quality, simpler communication and control technologies compared to wireless mobile technologies, and security and reliability. However, the deficiencies of these technologies, such as fixing, stillness, non-removability, dedication, and non-sharing, have severely affected the economic benefit of wired communication technologies, thus restricting their further development. Although IP telephony network technologies based on IP technology, such as H.323, SIP, and soft-switch, have many advantages in terms of the IP technology itself, their communication relies on translation between an IP address/domain name and an IP address, and the IP address associatively corresponds to a packet access network equipment and an access position. As a user equipment changes its access port and position, it is necessary for packet core network and packet access network equipment to reallocate and configure its IP address. This makes it difficult to implement bidirectional communication with numerous traditional PSTN/ISDN and PLMN user equipment and lacks the telephone service of communicating via a unique number and the management and control mechanism of telecommunication, unlike a PSTN or a PLMN telecommunication network. In particular, IP Internet network technology is based on a non-real time service bearer and a connectionless-oriented service, along with hybrid transmission and the switching of a real time service and a non-real time service, further lack the QoS and security assurance of a telecommunication network. The problem of not being able to convergently share the user equipment, the access network, and the core network in the communication technology field has led to an increase in the complexity of interconnection and interoperability among the different communication technologies, along with multiple and redundant coverage and the repeated construction of a multitude of communication network technologies, especially various wireless mobile technologies, as well as unsharing and the waste of unused communication resources, especially wired communication resources, and ultimately, an increase in cost and a decrease in economic benefit.

### SUMMARY OF THE INVENTION

One objective of invention is to provide a communication network system that converges a wireless mobile network and a wired discontinuous mobile network, to overcome the disadvantage of not being able to convergently share the above communication network resources. Thus, the system of the invention has the advantages of a wireless mobile communication system, such as being fixed and convenient, along with the advantages of a wired communication network system, such as abundant bandwidth resources, a friendly communication environment, high communication quality, simple technologies, and being safe and reliable.

Another objective of the invention is to provide a method applicable to a communication network system that combines a wireless mobile network and a wired discontinuous mobile network, to overcome the deficiency of not being able to convergently share different communication network technologies, in particular a wireless mobile communication technology and a wired communication technology, thus solving various problems with present communication technologies, such as redundant coverage and the waste of communication resources, making complex interconnection and interoperability relationships among different communication technologies easier, and implementing convergent sharing in the wired communication environment for different wireless mobile communication technologies.

The invention provides a communication network system that converges a wireless mobile network and a wired discontinuous mobile network. To attain the objects described above, the convergent communication network system provided by the invention comprises: a user equipment, an access network and a wireless/wired convergent mobile core network. The user equipment is connected to the access network system in a wired or a wireless manner, the access network may access a plurality of user equipment, and may be connected to the wireless/wired convergent mobile core network via a circuit switched domain traffic data and control signaling interface or a packet switched domain traffic data and control signaling interface, and the wireless/wired convergent mobile core network may be connected to a plurality of access networks, and may be interconnected to and communicate with external core networks of the same type, as well as other external communication networks, such as PSTN/ISDN, PLMN, PDN, Internet, and so on. There are three types of user equipment: a wired user equipment, a wireless/wired multi-mode user equipment, and a wireless user equipment, The access network may be formed in two ways, one is with the wired access network and the wireless access network independent of each other, and the other is with a wired end user access equipment, a wireless base station, and a convergent access controller incorporating a wireless access base station controller with a wired access end office access equipment.

To attain the above objects, the communication network system converging a wireless mobile network and a wired discontinuous mobile network is a convergence of a wireless mobile communication technology and a wired discontinuous mobile communication technology, and a convergence of wireless mobile communication and wired discontinuous mobile communication in terms of the systematic functions and structure of a core network, an access network, a user equipment, and a full network. Logically, the convergent communication network is divided into two independent layers: a wired discontinuous mobile communication network and a wireless mobile communication network. The wired discontinuous mobile communication network is a novel wired communication network with discontinuous mobility, which is simpler than wireless mobility, and may be regarded as a particular application of the wireless mobile communication technology in wired access. The wireless mobile communication network is a conventional communication network, such as a 2G GSM/GPRS or IS-95A/B, an IMT-2000 WCDMA, cdma2000 or TD-SCDMA, or a communication network in a future wireless mobile communication technology. Therefore, the wired user equipment is a novel wired communication user equipment with a discontinuous mobile function; the wireless user equipment is a wireless communication user equipment in a 2G GSM/GPRS or IS-95A/B, an IMT-2000 WCDMA, cdma2000 or TD-SCDMA, or a future wireless mobile communication technology; and the wireless/wired multi-mode user equipment is a multi-mode user equipment converging one or more of the wireless communication technologies in a 2G GSM/GPRS or IS-95A/B, an IMT-2000 WCDMA, cdma2000 or TD-SCDMA, or a future wireless mobile communication technology, with a wired discontinuous mobile technology. The wired user equipment is connected to the wireless/wired convergent mobile core network via a wired access network supporting discontinuous mobility for the wired discontinuous mobile communication; the wireless user equipment is connected to the wireless/wired convergent mobile core network via the wireless access network for the wireless mobile communication; the wireless/wired multi-mode user equipment may be connected to the wireless/wired convergent mobile core network via the wireless access network or the wired access network for the wireless mobile communication or the wired discontinuous mobile communication, and may hand over between the wireless access and the wired access, and between the wireless mobile communication and the wired discontinuous mobile communication; all the user equipment respectively use a unique and fixed number for communication. The access network is responsible for controlling and managing the wireless access resources and the wired access resources, for cooperating with the wireless/wired convergent mobile core network to provide the user equipment and the wireless/wired convergent mobile core network with wireless or wired bearer services, along with wireless or wired access bearer services, and for supporting wireless mobility and wired discontinuous mobility management and communication management. Under support and cooperation from the user equipment and the access network, the wireless/wired convergent mobile core network provides the user equipment with communication management, wireless mobility and wired discontinuous mobility management, along with security management, and is responsible for allocation management of interfaces and channel resources between the access network and the mobile core network, along with network operation and maintenance management, and the wireless/wired convergent mobile core network is interconnected to and communicates with external core networks with the same type, along with other external communication networks via communication interfaces and protocols.

Compared with conventional separated communication technologies, the communication network system converging a wireless mobile network and a wired discontinuous mobile network and the method thereof not only incorporates the respective advantages of the wireless mobile communication and wired communication technologies and networks, but also overcomes their disadvantages and solves problems with the conventional wireless mobile communication and wired communication, such as the different technologies, mutually separated networks, complex interconnections and interoperability, the waste and non-sharing of communication resources, and the high cost.

### BRIEF DISCRIPTION OF THE DRAWINGS

FIG. 1 illustrates the structural composition and a communication application of a convergent network of the communication network system in accordance with an embodiment of the invention.

FIG. 2 illustrates the structural composition and a different example of a communication application of a convergent network of the communication network system of in accordance with an embodiment of the invention.

### DETAILED DESTRIPTION OF THE INVENTION

A detailed description of the system and the method thereof will be given below in conjunction with the accompanying drawings.

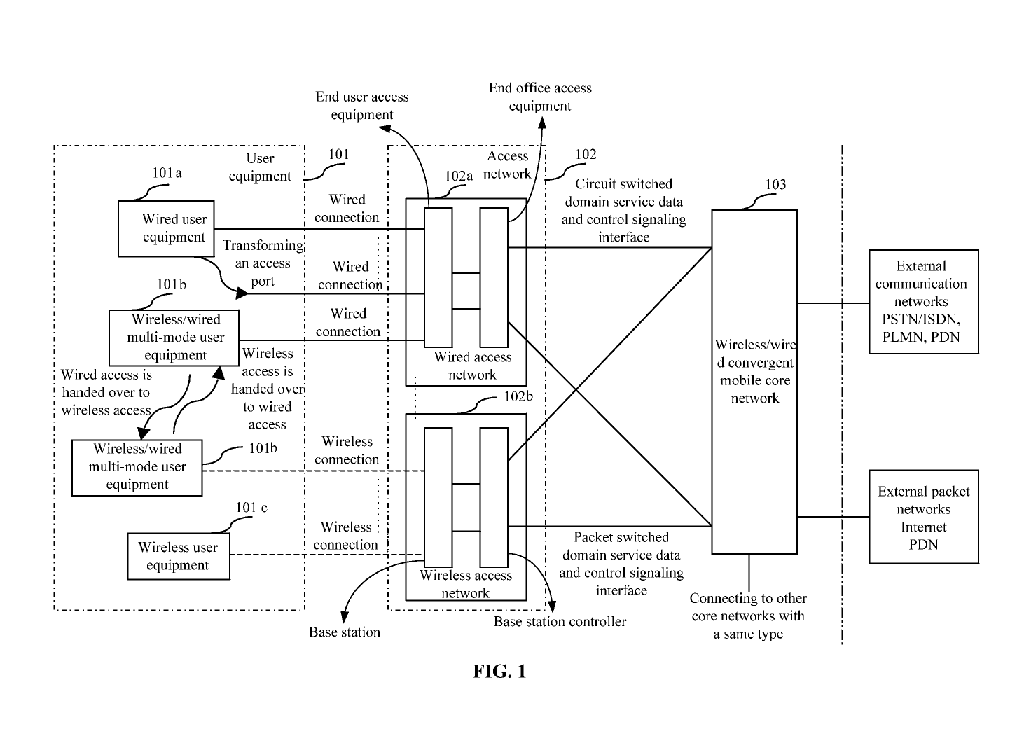

FIG. 1 shows the structure and composition of a convergent network of the communication network system. As shown in FIG. 1, the communication network system combines a wireless mobile network and a wired discontinuous mobile network and includes a user equipment 101, an access network 102, and a wireless/wired convergent mobile core network 103. There are three types for the user equipment 101: a wired user equipment 101a, a wireless/wired multi-mode user equipment 101b, and a wireless user equipment 101c; the wired user equipment 101a has a wired discontinuous mobile communication function; the wireless user equipment 101c has a wireless mobile communication function; and the wireless/wired multi-mode user equipment has both the wireless mobile communication function and the wired discontinuous mobile communication function, and may hand over between them; each of the user equipments uses a unique and fixed number for communication. The access network 102 includes a wired access network 102a and a wireless access network 102b, which are independent of each other; the wired access network 102a includes an end user access device and an end office access device, and is mainly responsible for managing and controlling wired access resources, for cooperating with the wireless/wired convergent mobile core network 103 to provide the user equipment 101a, 101b and the wireless/wired convergent mobile core network 103 with wired bearer services and wired access bearer services, and for supporting the wired discontinuous mobile communication; the wireless access network 102b includes a base station and a base station controller, and is mainly responsible for managing and controlling wireless access resources, for cooperating with the wireless/wired convergent mobile core network 103 to provide the user equipment 101 and the wireless/wired convergent mobile core network 103 with wireless bearer services and wireless access bearer services, and for supporting the wireless mobile communication. The wireless/wired convergent mobile core network 103 is connected to a plurality of wired access networks 102a and wireless access networks 102b via a circuit switched domain or a packet switched domain traffic data and control signaling interface, mainly provides the user equipment 101 with communication management, wireless mobility and wired discontinuous mobility management, along with security management, and is responsible for allocation management of interfaces and channel resources between the access network 102 and the wireless/wired convergent mobile core network 103, along with network operation and maintenance management; the wireless/wired convergent mobile core network 103 is interconnected to and communicates with core networks of the same type, along with other external communication networks via communication interfaces and protocols.

In the structure of the convergent network of the invention shown in FIG. 1, the wired user equipment 101a and the wireless/wired multi-mode user equipment 101b may change their access address and position in the wired discontinuous mobile communication network, and use the same wired access technology to transfer to the coverage area of wired access networks in other wired discontinuous mobile communication networks for a plurality of communication services and applications, without the need to change their fixed and unique numbers; the wireless user equipment 101c and the wireless/wired multi-mode user equipment 101b may also change their access address and position in the wireless mobile communication network, and use the same wireless access technology to transfer to the coverage area of wireless access networks in other wireless mobile communication networks for a plurality of communication services and applications, without needing to change their fixed and unique numbers.

As shown in FIG. 1, the wireless/wired user equipment 101b first operates in a wireless mobile communication network by accessing it as a wireless mobile user equipment; the wireless mobile communication network comprises the wireless access network 102b in the access network 102, along with the wireless/wired convergent mobile core network 103; the access network 102b provides wireless access services, such as wireless access resources, wireless access bearer, and so on thereto, and is connected to the wireless/wired convergent mobile core network 103; the core network 103 performs wireless mobility management, such as location registration, hand over, roaming, and so on, security management, such as authorization, authentication and so on, along with communication management of various communication services, such as voice, data, and multimedia in a circuit switched domain and a packet switched domain thereon, and provides the user equipment 101b with interconnection and communication with other communication networks of the same type, and with other external communication networks.

When the wireless/wired user equipment 101b changes from wireless access and the wireless mobile communication network to wired access, and is connected to the wired access network 102a in the access network 102, the wireless/wired convergent mobile core network 103 first performs security management, comprising authorization and authentication thereon, and only a legal user is permitted to access and communicate; at the same time, the core network 103 modifies and updates user information and data for the user equipment 101b, such as the original access attributes, access ports and locations, and so on, that have been stored thereby for wired discontinuous mobility management; after security authentication and the access process are completed, the core network 103 directs the wireless access network 102b to release all the wireless access resources originally provided thereto and to stop providing wireless access services thereto; at this point, the multi-mode wireless/wired user equipment 101b communicates as a wired mobile user equipment in the wired discontinuous mobile communication network accessed thereby; the wired discontinuous mobile communication network comprises the wired access network 102a in the access network 102, along with the wireless/wired convergent mobile core network 103; the access network 102a provides various wired access services, such as wired access resources, wired access bearer, and so on, and is connected to the wireless/wired convergent mobile core network 103; the core network 103 performs wired discontinuous mobility management, such as location registration, wired/wireless hand over, roaming, and so on, security management, such as authorization, authentication, and so on, along with communication management of various communication services, such as voice, data, and multimedia in a circuit switched domain and a packet switched domain thereon, and provides the user equipment 101b with interconnection and communication with other communication networks of the same type, and with other external communication networks.

When the multi-mode wireless/wired user equipment 101b again changes from the wired discontinuous mobile communication network, comprising an accessed wired access network 102a and the core network 103, to wireless access, and is connected to the wireless access network 102b, the wireless access network 102b first performs security management, including access control, authorization, and authentication thereon, and only a legal user is permitted to access and communicate; at the same time, the core network 103 modifies and updates user information and data for the user equipment 101b, such as access attributes, locations, and so on, that have been stored thereby; after the access process and security authentication are completed, the core network 103 directs the wired access network 102a to release all the wired access resources originally provided to the user equipment 101b and to stop providing wired access services thereto; at this point, the wireless/wired user equipment 101b again communicates as a wireless mobile user equipment in a wireless mobile communication network accessed thereby.

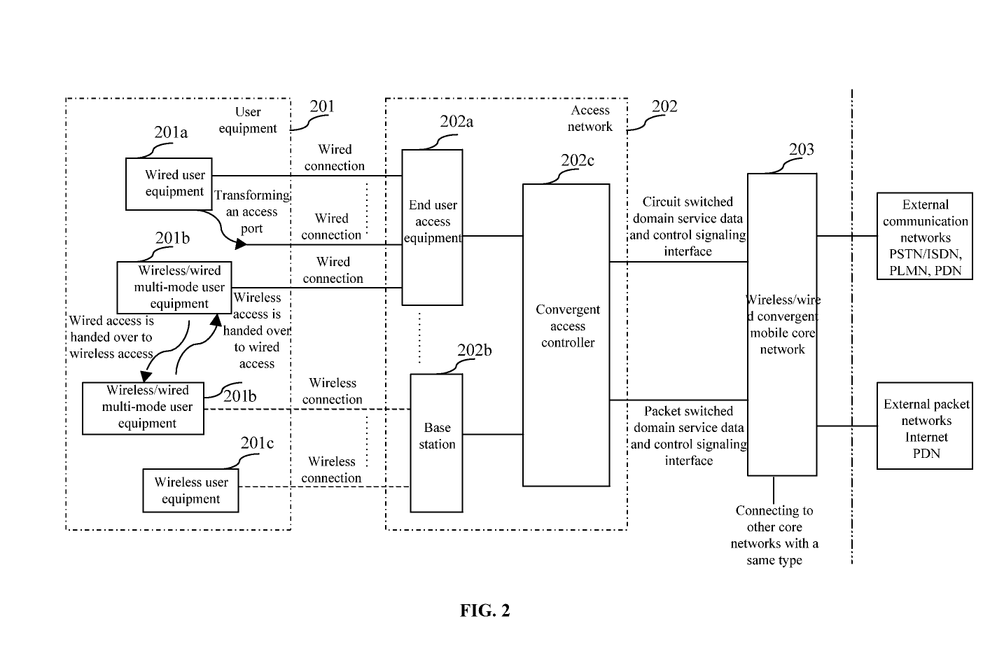

FIG. 2 shows the structure and composition of another convergent network of the communication network system of the invention to give the access network 202 deeper convergence. The only difference from the former convergent network in structure is that the access network 202 does not include independent wired access and wireless access networks, but includes a wired end user access device 202a, a wireless base station 202b, along with a convergent access controller 202c incorporating a base station controller in a wireless access network with an end office access device in a wired access network. The convergent access controller 202c is responsible for managing and controlling wired and wireless access resources, and for connecting to the core network; under control of the convergent access controller 202c, the end user access device 202a provides the wired user equipment 201a and the wireless/wired multi-mode user equipment 201b with wired connection and wired access services, and the base station 202b provides the wireless user equipment 201c and the wireless/wired multi-mode user equipment 201b with wireless connection and wireless access services; the access network 202 cooperates with the wireless/wired convergent mobile core network 203 to provide the user equipment 201 and the wireless/wired convergent mobile core network 203 with convergent wired/wireless bearer services and wired/wireless access bearer services, to simultaneously support wired discontinuous mobile communication and wireless mobile communication.

In the structure of the convergent network of the present invention as shown in FIG. 2, the wired user equipment 201a and the wireless/wired multi-mode user equipment 201b each use a unique and fixed number to transform the end user access devices 202a and wired access ports in different positions for wired discontinuous mobile communication; also, the wireless user equipment 201c and the wireless/wired multi-mode user equipment 201b each use a unique and fixed number to transform base stations 202b and wireless access channels in different positions for wireless mobile communication.

As shown in FIG. 2, the wireless/wired user equipment 201b first communicates as a wireless mobile user equipment in a wireless mobile communication network accessed thereby; the wireless mobile communication network, which includes the base station 202b and the convergent access controller 202c in the access network 202, and the wireless/wired convergent mobile core network 203, the base station 202b, and the convergent access controller 202c, provides various wireless access services, such as wireless access resources, wireless access bearer, and so on thereto, and is connected to the wireless/wired convergent mobile core network 203; the core network 203 performs wireless mobility management, such as location registration, hand over, roaming, and so on, security management such as authorization, authentication, and so on, along with communication management for various communication services, such as voice, data, and multimedia in a circuit switched domain and a packet switched domain thereon, and provides the user equipment 201b and 201c with interconnection and communication with other communication networks of the same type, and with other external communication networks.

When the wireless/wired user equipment 201b changes from wireless access and the wireless mobile communication network to wired access, and is connected to the end user access device 202a in the access network 202, the wireless/wired convergent mobile core network 203 first performs security management, including access control, authorization, authentication, and so on thereon via the convergent access controller 202c and the end user access device 202a, and only a legal user is permitted to access and communicate; at the same time, the core network 203 modifies and updates user information and data for the user equipment 201b, such as the original access attributes, access ports, locations, and so on, that have been stored thereby for wired discontinuous mobility management; after the access process and the security authentication are completed, the core network 203 directs the convergent access controller 202c controlling the base station 202b to release all the wireless access resources originally provided to the user equipment 201b and to stop providing wireless access services thereto; at this point, the wireless/wired user equipment 201b has already communicated as a wired mobile user equipment in a wired discontinuous mobile communication network accessed thereby; the wired discontinuous mobile communication network, which includes the end user access device 202a, the convergent access controller 202c, and the wireless/wired convergent mobile core network 203, 202a, and 202c in the access network 200, provide the user equipment 201a and 201b with various wired access services, such as wired access resources, wired access bearer, and so on, and are connected to the wireless/wired convergent mobile core network 203; the core network 203 performs wired discontinuous mobility management, such as access port and location registration, wired/wireless hand over, roaming, and so on, security management, such as authorization, authentication, and so on, along with communication management for various communication services, such as voice, data, and multimedia in a circuit switched domain and a packet switched domain thereon, and provides the user equipment 201a and 201b with interconnection and communication with other communication networks of the same type, and with other external communication networks.

When the wireless/wired user equipment 201b changes from wired access to wireless access, and is connected to the base station 202b again, the core network 203 first performs security management, including access control, authorization, and authentication thereon via the wireless access networks 202c and 202b, and only a legal user is permitted to access and communicate; at the same time, the core network 203 modifies and updates user information and data for the user equipment 201b, such as access attributes, locations and so on, that have been stored thereby; after the access process and security authentication are completed, the core network 203 directs 202c, which is controlling 202a to release all the wired access resources originally provided to the user equipment 201b and to stop providing wired access services thereto; at this point, the wireless/wired user equipment 201b again communicates as a wireless mobile user equipment in a wireless mobile communication network accessed thereby.

The above embodiments of the invention are not limited to communication within the same communication network. The advantages of the invention may also be implemented via communication applications and other communication services between the communication network of the invention and other external communication networks of the same type, along with other different communication networks, such as PSTN/ISDN, PLMN, PDN, Internet, and so on.

The principles, structure, and functions of the invention, along with the preferred embodiments having been described above in detail, which make it possible for those skilled in the art to produce, utilize or use the invention. Modification and various variations to these preferred embodiments are apparent to those skilled in the art, and the general principles defined herein may be applicable to other embodiments without employing inventive creativity. Therefore, the invention is not limited to the embodiments illustrated herein, but is contemplated according to the broadest scope formed by the principles and new characteristics disclosed herein.

What is claimed is:

1. A communication network system that converges a wireless mobile network and a wired discontinuous mobile network, comprising a user equipment, an access network, and a wireless/wired convergent mobile core network, wherein
the user equipment comprises a wired user equipment, a wireless/wired multi-mode user equipment, and a wireless user equipment;
the wired user equipment is a novel wired communication user equipment with a discontinuous mobile function;
the wireless user equipment is a wireless communication user equipment of a 2G GSM/GPRS, IS-95A/B type and so on, an IMT-2000 WCDMA, cdma2000 or TD-SCDMA type equipment, or equipment of a future wireless mobile communication technology; and
the wireless/wired multi-mode user equipment is a multi-mode user equipment converging one or more following wireless technologies 2G GSM/GPRS, IS-95A/B and so on, an IMT-2000 WCDMA, cdma2000 or TD-SCDMA, or a future wireless mobile communication technology, with a wired discontinuous mobile technology.

2. The communication network system in accordance with claim 1, wherein
the user equipment has the ability to access an access network system in a wired or a wireless manner;
the access network system has the ability to access a plurality of user equipment, and is connected to a wired/wireless convergent mobile core network via a circuit switched domain traffic data and control signaling interface or a packet switched domain traffic data and control signaling interface; and
the wireless/wired convergent mobile core network is connected to a plurality of access network systems, and is interconnected to and communicates with external core networks of the same type, and with other external communications networks, such as PSTN/ISDN, PLMN, PDN, Internet, and so on via communication interfaces and protocols.

3. The communication network system in accordance with claim 1, wherein the access network is responsible for
managing and controlling wireless access resources and wired access resources,
cooperating with the wireless/wired convergent mobile core network to provide the user equipment and the wireless/wired convergent mobile core network with wireless and wired bearer services, along with wireless and wired access bearer services, and
supporting wireless mobility and wired discontinuous mobility management, along with communication management.

4. The communication network system in accordance with claim 3, wherein the access network comprises a wired access network and a wireless access network that are independent of each other.

5. The communication network system in accordance with claim 4, wherein
the wired access network comprises an end user access device and an end office access device, and is responsible for managing and controlling the wired access resources, cooperating with the wireless/wired convergent mobile core network to provide the user equipment and the wireless/wired convergent mobile core network with the wired bearer services, along with the wired access bearer services, and supporting wired discontinuous mobile communication; and
the wired access network comprises a base station and a base station controller, and is responsible for managing and controlling the wireless access resources, cooperating with the wireless/wired convergent mobile core network to provide the user equipment and the wireless/wired convergent mobile core network with the wireless bearer services, along with the wireless access bearer services, and supporting wireless mobile communication.

6. The communication network system in accordance with claim 3, wherein
another access network comprises a wired end user access device, a wireless base station, and a converging access controller incorporating a wireless access base station controller with a wired access end office device;
the convergent access controller is mainly responsible for simultaneously managing and controlling the wired access resources and the wireless access resources, and for connecting to the core network;
under the control of the convergent access controller, the end user access device provides the wired user equipment and the wireless/wired multi-mode user equipment with wired connection and wired access services, and the base station provides the wireless user equipment and the wireless/wired multi-mode user equipment with wireless connection and wireless access services; and
under cooperation from the core network, the access network provides the user equipment and the wireless/wired convergent mobile core network with convergent wired/wireless bearer services and wired/wireless access bearer services, and supports wired discontinuous mobile communication and wireless mobile communication.

7. The communication network system in accordance with claim 1, wherein
under the support and cooperation of the user equipment and the access network, the wireless/wired convergent mobile core network provides the user equipment with communication management, wireless mobility and wired discontinuous mobility management, and security management, and is responsible for allocation management of interfaces and channel resources between the access network and the mobile core network, along with network operation and maintenance management, and
the wireless/wired convergent mobile core network is interconnected to and communicates with external core networks of the same type, along with other external communication networks via communication interfaces and protocols.

8. A method for providing a communication network converging a wireless mobile network and a wired discontinuous mobile network, comprising
converging a wireless mobile communication technology and a wired discontinuous mobile communication technology, and
converging wireless mobile communication and wired discontinuous mobile communication in terms of the system functions and structure of a core network, an access network, a user equipment, and a full network; wherein
the communication network is logically divided into two independent layers: a wired discontinuous mobile communication network and a wireless mobile communication network;
the wired discontinuous mobile communication network is a novel wired communication network with discontinuous mobility, and may be regarded as a particular application of a wireless mobile communication technology in a wired environment; and
the wireless mobile communication network is a communication network of a 2G GSM/GPRS or IS-95A/B, an IMT-2000 WCDMA, cdma2000 or TD-SCDMA, or a future wireless mobile communication technology type.

9. The method in accordance with claim 8, wherein,
a wired user equipment is connected to the wireless/wired convergent mobile core network via a wired access network supporting discontinuous mobility for wired discontinuous mobile communication;
a wireless user equipment is connected to the wireless/wired convergent mobile core network via a wireless access network for wireless mobile communication;
a wireless/wired multi-mode user equipment is connected to the wireless/wired convergent mobile core network via the wireless access network or the wired access network for wireless mobile communication or wired discontinuous mobile communication, and hands over between wireless access and wired access, or between wireless mobile communication and wired discontinuous mobile communication; and
each user equipment uses a unique and fixed number for communication.

10. The method in accordance with claim 8, further comprising the following steps:
a) providing the user equipment with wireless access services, such as wireless access resources, wireless access bearer, and so on, and connection to the wireless/wired convergent mobile core network by the access network;
performing wireless mobility management, such as location registration, hand over, roaming, and so on, security management, such as authorization, authentication, and so on, along with communication management of various communication services, such as voice, data, and multimedia in a circuit switched domain and a packet switched domain; and providing the user equipment with interconnection and communication with other communication networks of the same type, and with other external communication networks through the core network while the wireless user equipment or the wireless/wired multi-mode user equipment accesses the convergent communication network of the present invention as a wireless user equipment;
b) performing security management, such as authorization, authentication, and so on, on the wireless/wired multi-mode user equipment by the wireless/wired convergent mobile core network via access network, modifying and updating user information and data for a valid user equipment, such as the original access attributes, access ports and locations, and so on, that have been stored by the core network as the wireless/wired multi-mode user equipment transforms from wireless access to wired access; and instructing the access network to release all the wireless access resources originally provided to the user equipment and to stop providing wireless access services thereto by the core network after security authentication and the access process are completed;
c) implementing wired discontinuous mobile communication in an accessed communication network of the invention as a wired mobile user equipment by the wireless/wired multi-mode user equipment; providing the user equipment with various wired access services, such as wired access resources, wired access bearer, and so on, and being connected to the wireless/wired convergent mobile core network by the access network; performing wired discontinuous mobility management, such as the registration of access ports and locations, hand over, roaming, and so on, security management, such as authorization, authentication, and so on, along with communication management of various communication services, such as voice, data, and multimedia in a circuit switched domain and a packet switched domain; and providing the user equipment with interconnection and communication with other communication networks of the same type, and with other external communication networks through the core network;
d) performing security management, such as authorization, authentication, and so on, on the wireless/wired multi-mode user equipment by the wireless/wired convergent mobile core network via the access network, modifying and updating user information and the data for a valid user equipment, such as the original access attributes, locations, and so on, that have been stored by the core network as the wireless/wired multi-mode user equipment hand over from wired access to wireless access; and directing the access network to release all the wired access resources originally provided to the user equipment and to stop providing wired access services thereto by the core network after the security authentication and access process are completed; and
e) implementing wireless mobile communication in an accessed communication network of the invention by the wireless/wired multi-mode user equipment as a wireless mobile user equipment.
